(19) United States
(12) Patent Application Publication
(10) Pub. No.: US 2018/0214995 A1
(43) Pub. Date: Aug. 2, 2018

(54) Welding Station

(71) Applicant: Daniel Johnson, Upton, MA (US)

(72) Inventor: Daniel Johnson, Upton, MA (US)

(21) Appl. No.: 15/420,024

(22) Filed: Jan. 30, 2017

(51) Int. Cl. B23K 37/053

(52) U.S. Cl. CPC B23K 37/0538; B23K 2203/05

(57) ABSTRACT

Disclosed herein is a welding station for holding a workpiece, comprising: (a) a base; (a) purge gas manifold, operatively connected to the welding station, or incorporated into the base, to act as a conduit for an unreactive or passivating purge gas; (c) a rotatable chuck stage for holding the workpiece, comprising a purge gas outlet, and having a first axis of rotation that allows the workpiece to swing into place at a desired angle, and a first detent to lock the motion of the rotatable stage once the desired angle in the first axis of rotation is attained.

### FIELD OF THE INVENTION

The present application for patent is in the field of welding and more specifically is in the field of welding stations or fixtures.

### BACKGROUND

Welding procedures in industry require experienced welders whose work product complies with the appropriate standards in the apparatus, device or a part(s) thereof being manufactured, formed or repaired. Accordingly, it is desirable that this process is carried out by a trained and/or experienced welder. Such welders are scarce and their skilled labor may be expensive.

Welds are often inspected and certified to assure that they meet the requirements of the application. This is particularly true for welded equipment in the pharmaceutical and semiconductor industries, where critical chemical substances come into contact with welded pipes and other equipment, the electric power generation industry where welds must endure high pressure and temperature conditions over an extended period of time, the nuclear industry, where welded materials must withstand not only temperature and pressure but also radiation challenges, and the military where welds must withstand a wide variety of physical, mechanical and chemical challenges.

In order to assure quality and reliability in the welding arts, protocols of certifications and procedures have been devised by various professional organizations and standards agencies such as the American Welding Society (AWS), the American Society of Mechanical engineers (ASME), the American Petroleum Institute (API), the American Bureau of Shipping (ABS), and the Canadian Welding Bureau (CWB). In some cases, the welder's work product is required to meet certain general or application specific standards such as Military Standards (MIL-STD), Department of Transportation standards (DOT), State and Local Certification Codes, International Organization for Standardization (ISO) Standards, British Standards (BS), European Union (CEN) standards, German Standards (DIN and others), and the like.

Welders in training sometimes use self devised fixtures to practice the various welds and procedures necessary to obtain certification for a certain type of weld. While such a practice may be helpful it is possible that safety issues may arise with nonstandard equipment. Moreover, there is always the possibility that student welders may practice incorrectly as they attempt to adjust to various nonstandard conditions inherent in improvised equipment.

Accordingly, various tools have been devised to hold welding work-pieces securely and in the required positions. For example, U.S. Pat. No. 8,915,740 to Zboray et al. and U.S. Design Pat. No. 614,217 to Peters et al. disclose a stand for receiving a welding coupon that is adjustable between a first and at least a second substantially different position. However, the disclosed devices do not offer the flexibility required to hold the welding coupon/work-piece in place in the variety of different configurations and orientations associated with standards for welder qualification. Moreover, welding procedures often require the introduction of an inert or otherwise unreactive gas to shield the hot weld from corrosion or oxidation. These needs are addressed in the invention disclosed herein.

### BRIEF DESCRIPTION OF THE DRAWINGS

FIG. 1 illustrates an embodiment of a welding station disclosed herein, with the workpiece coupon tilted at a substantially right angle from the vertical.

FIG. 2 shows an embodiment of the welding station disclosed herein. FIG. 2(a) illustrates an embodiment of a welding station disclosed herein with the workpiece coupon tilted, relative to the vertical and held in place by the first detent. FIG. 2(b) illustrates an embodiment of the chuck stage of FIG. 2(a) in greater detail.

### DETAILED DESCRIPTION OF THE DRAWINGS

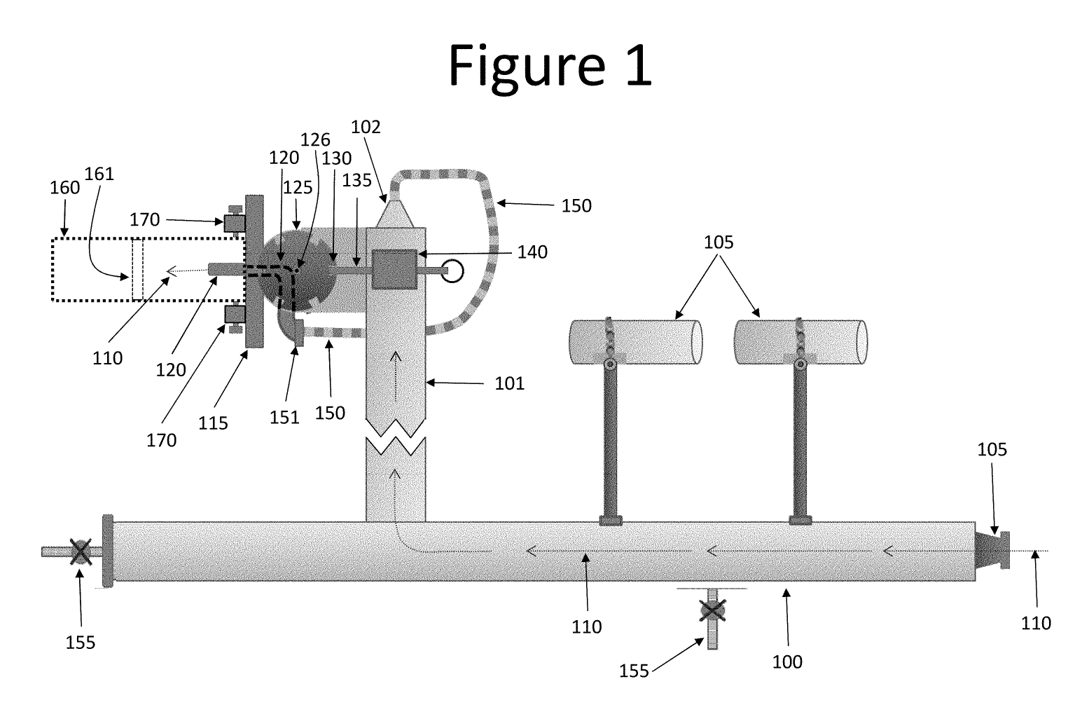

FIG. 1 illustrates an embodiment of a welding station disclosed herein, with the workpiece coupon tilted at a substantially right angle from the vertical. The base, also functioning as a main gas manifold 100 is shown fitted with a gas inlet port 105 into which an inert or otherwise unreactive gas 110 is introduced. In the illustration, the gas manifold is incorporated into the base and the sample gas manifold. Branching from the main gas manifold a sample gas manifold 101 at one branch and a purge valve 155. The sample gas manifold 101, which can be of a selected length, depending on the application, is shown capped by an outlet port 102 connected to a shielded gas line 150 through which the inert or otherwise unreactive gas 110 flows to a gas fitting 151, connected to the purge gas outlet 120. The workpiece coupon 160, with weld position 161 is secured to the chuck stage 115, in this illustration, by set screws 170. The chuck stage 115 may undergo swing rotation about a first axis emanating from a pivot point or locus of points 126, said axis being substantially perpendicular to the plane of the illustration The chuck stage 115 is mounted on a slotted disk 125 at the pivot point 126 in such a way as to allow swing rotation as described supra. Slots 130 in the slotted disk 125 are configured to engage with a detent pin 135, which is held in place by a spring within housing 140. The welding station may also include a tacking station 105 for tack-welding the workpiece coupon together prior to performing the permanent weld.

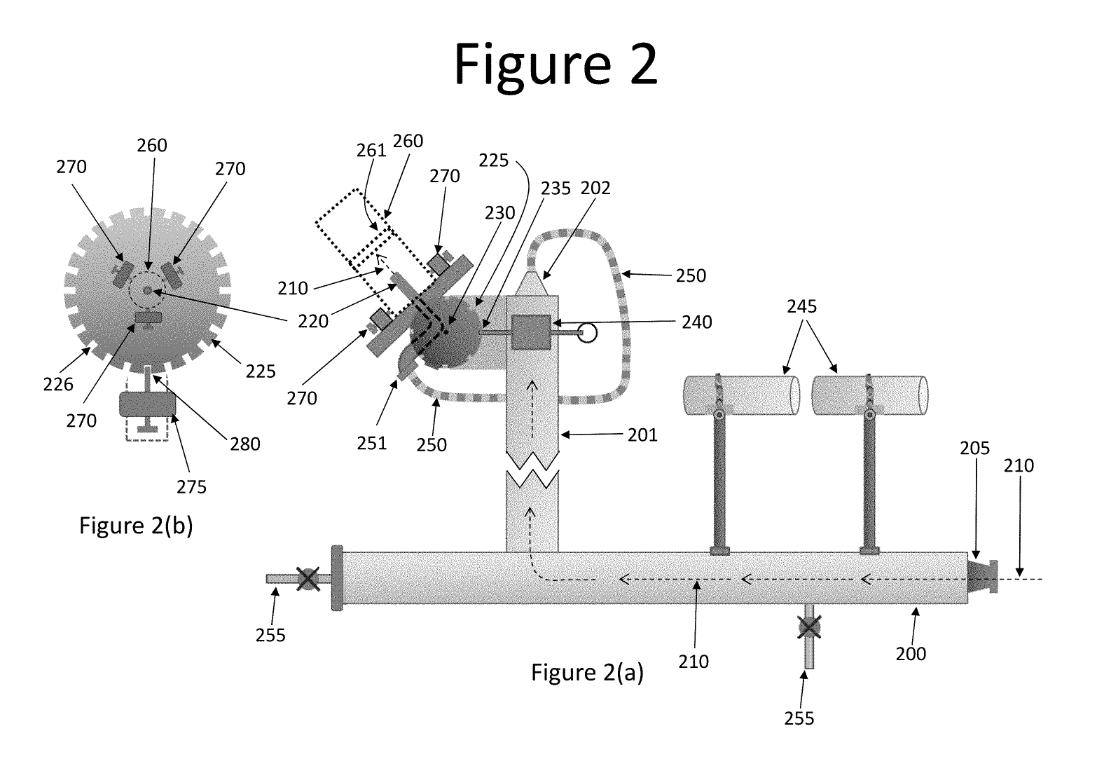

FIG. 2 shows an embodiment of the welding station disclosed herein. FIG. 2(a) illustrates an embodiment of a welding station disclosed herein with the workpiece coupon tilted at an angle of 45°, relative to the vertical and held in place by a first detent. The base, also functioning as a main gas manifold 200 is shown fitted with a gas inlet port 205 into which an inert or otherwise unreactive gas 210 is introduced. In the illustration, the gas manifold is incorporated into the base and the sample gas manifold. Branching from the main gas manifold, a sample gas manifold 201 at one branch and a purge valve 255. The sample gas manifold 201, which can be of a selected length, depending on the application, is shown capped by an outlet port 202 connected to a shielded gas line 250 through which the inert or otherwise unreactive gas 210 flows to a gas fitting 251 to the purge gas outlet 220. The workpiece coupon 260, with weld position 261, is secured to the chuck stage 215, in this illustration, by set screws 270. The chuck stage 215 may undergo swing rotation about a first axis emanating from a pivot point or locus of points 226, said axis being substantially perpendicular to the plane of the illustration The chuck stage 215 is mounted on a slotted disk 225 at the pivot point 226 in such a way as to allow swing rotation as described supra. Slots 230 in the slotted disk 225 are configured to engage with a detent pin 235, which is held in place by a spring within housing 240. The welding station may also include a tacking station 205 for tack-welding the workpiece coupon together prior to performing the permanent weld. FIG. 2(b) illustrates an embodiment of the chuck stage of FIG. 2(a) in greater detail. The chuck stage 225 may itself be slotted and rotatable (concentric rotation) about an axis perpendicular to the plane of the illustration, emanating from a point or locus of points coincident with the purge gas outlet port 220. In this embodiment, slots 226 are configured to engage with detent pin 280 which is held in place by a spring within housing 275. The workpiece coupon 260 is secured to the chuck stage 215, in this illustration, by set screws 270.

### DETAILED DESCRIPTION

As used herein, the conjunction “and” is intended to be inclusive and the conjunction “or” is not intended to be exclusive unless otherwise indicated. For example, the phrase “or, alternatively” is intended to be exclusive. As used herein, a detent is any device that limits rotational motion.

As used herein, the words “comprise” or “comprising” are understood in a non-limiting sense to mean that items following the word are included, but items not specifically mentioned are not excluded. The words, “include” and “contain” may be used interchangeably with the “comprise,” as may be appropriate.

As used herein, the word “exemplary” is understood to be an adjective serving to point out an illustrative example and is not intended to indicate preference in any way.

As used herein, a reference to an element by the indefinite article “a” does not exclude the possibility that more than one of the elements is present, unless the context clearly requires that there be one and only one of the elements. Thus the statement that a structure comprises two specified elements includes the possibility that the structure includes two, three, four or more such specified elements, as well as unspecified elements.

Disclosed herein is a welding station for holding a workpiece, comprising: (a) a base; (a) purge gas manifold, operatively connected to the welding station, or incorporated into the base, to act as a conduit for an unreactive or passivating purge gas; (c) a rotatable chuck stage for holding the workpiece, comprising a purge gas outlet, and having a first axis of rotation that allows the workpiece to swing into place at a desired angle, and a first detent to lock the motion of the rotatable stage once the desired angle in the first axis of rotation is attained.

The welding station disclosed supra, may also be augmented in several ways. For example, a tack station may be incorporated to allow temporary welding of the workpiece coupon before it is clamped into place on the chuck stage.

The base may serve as a gas manifold for carrying the unreactive or passivating purge gas or the gas manifold may be a separate conduit. Base materials may comprise a pipe, a hollow bar, or other hollow, material suitable for use in a welding environment. In addition, the base may be a strut or I-beam or other cross sections such as triangular, square, rectangular, circular, elliptical, oval shaped, s-beam, i-beam, c-beam, t-beam n-beam, m-beam, n-sided polygonal, where n=5 to 20, conical and the like. Closed cross sections may also be used as gas manifolds while open cross sections may require a separate conduit.

The welding station disclosed herein makes use of detents to hold the chuck stage at the desired angle(s). In the present context, a detent is used to stop the swing rotation or concentric rotation of the chuck stage Detents may comprise devices of various levels of complexity from a simple metal pin to a machine. In another context, the term may also be used for the method involved. A detent may comprise a tab, interacting with a surface to impede rotation, a gravity or spring-actuated lever paired with a notched wheel, a spring-biased ball bearing coupled to depressions or holes on or in a surface, a linear spring that snaps a restraint into notches in a surface, or a ratchet.

In addition to holding a cylindrically shaped workpiece, the chuck stage may also be configured to hold other shapes of material such as a flat plate or structural materials of geometrical cross section such as, without limitation, I-beam or other cross sections such as triangular, square, rectangular, circular, elliptical, oval shaped, s-beam, i-beam, c-beam, t-beam n-beam, m-beam, n-sided polygonal, where n=3 to 20, conical and the like.

The purge gas may be selected for the application. For example, it may be desirable to blanket the weld and prevent oxidation of the weld area. Accordingly, the purge gas may comprise noble gases such as helium, neon, argon, krypton, or xenon. In addition, nitrogen is usually unreactive and may also be useful. The choice of unreactive gas may depend on the orientation of the workpiece coupon. For example, welding a pipe coupon with its open end turned up may require a heavier-than-air gas or gas mixture that will stay in the pipe. With the open end turned down, a lighter-than-air gas such as helium may be desirable because it is less likely to “pour” out of the tube. Densities of gasses are usually commensurate with their atomic or molecular weights, which may be obtained on a periodic chart or other common reference.

In addition to unreactive gasses it may be desirable to select a gas that passivates the weld chemically by reacting to form a nearly impervious layer of metal oxide, nitride, boride, carbide, silicide or other surface coating. Without limitation, exemplary passivating gases may include oxygen, ozone, nitrous oxide, and a nitrogen source gas that includes molecules consisting of nitrogen atoms and other atoms having one proton, CF₄, BF₃, acetylene, ethylene, or silicon containing gasses in which the silicon may be bound to an oxygen atom. Passivating gasses may be used with reactive metals such as, without limitation, zinc or zinc plated steel, copper, titanium, aluminum, zirconium, hafnium or the like.

It is also contemplated that the welding station disclosed herein may be used to weld plastic or polymer materials such as, without limitation, polyethylene, poly vinyl chloride, acrylic materials, including methacrylic materials, fluoropolymers and the like.

Optionally, the welding station may have a cleaning station in which the welding rod is fed through a surface-cleaning apparatus, such as a multi-wheel shot-peening apparatus, comprising air and wheel blast methods. The shot-peening apparatus removes an oxide layer, such as iron oxide if the rod material is steel, or tungsten oxide(s) if the rod material is tungsten. Shot-peening may also be used to effectively remove the mill scale and ensure a clean surface for a subsequent surface treatment station. These examples are not limiting and it is to be understood that other methods of cleaning, such as sand blasting, may be used instead of shot-peening.

While the welding station disclosed herein is not intended to be limited by the type of material being welded, one material that poses a particular challenge is stainless steel. Stainless steel can be generally classified as ferritic stainless steel, such as SUS430 and austenitic stainless steel, such as SUS304. Ferritic stainless steel is generally used as lining material for constructions, surface material for domestic articles, and for various decorative facilities. For these purposes, ferritic stainless steel should have satisfactorily high surface gloss or brightness. On the other hand, austenitic stainless steel is used in many industrial applications because of its higher corrosion and chemical resistance compared to ferritic stainless steel. Accordingly, it is frequently desirable that austenitic stainless steel is buffed to achieve high surface gloss or brightness. The welding station of the current disclosure may optionally serve as a buffing station in which stainless steel is buffed to a high gloss, while the workpiece coupon is held at the preferred angle or angles. Known methods of buffing include circular buffing with a medium grit pad, followed by circular buffing with a fine grit pad. Finishing the workpiece may be accomplished with a felt pad, optionally using a buffing compound. Buffing wheels suitable for buffing welded products may be obtained from, for example, Rex-Cut Products, Inc. of Fall River, Mass.

Welding of metal products such as stainless steel may result in heat tint discoloration in the zone affected by heat. The heat tinting is generally a thickening of the naturally occurring oxide layer on the surface of stainless steel. As heat tint colors are formed on stainless steel, chromium is drawn from below the surface of the metal to form a chromium rich oxide surface layer. This leaves the metal just below the surface with a lower chromium level. The reduction in the subsurface chromium typically reduces the corrosion resistance of the steel. In order to restore the corrosion resistance of the finished stainless steel product, the weld heat tint needs to be removed. Removal of heat tint from welds of stainless steel or other metals may be done by techniques such as using pickling pastes, wire brushing, grinding or electrolytic methods. The welding station of the present disclosure may further be used as a mount for the workpiece coupon during cleaning. For example, electrolyte methods may use a brush with electrically conductive bristles, such as bristles made of carbon fiber strands, supplied with an electric current and an electrolyte solution. When the carbon fiber tipped brush with the electric current and electrolyte solution is applied to the welded area affected by heat tint, an electrochemical cleaning of welded area occurs. Weld cleaning systems of this type are used to clean welds formed using gas tungsten arc welding, also known as tungsten inert gas (TIG) welding.

In addition to the above, the welding station disclosed herein may also include a means for holding the welding torch cable to prevent pulling of the cable during the welding operation. For example, without limitation, cable holders may include combinations of hooks, loops, springs wires, coiling boxes, clamps, and the like.

The welding station, disclosed herein, may be used as a teaching and testing tool for qualifying and certifying candidate welders. As noted supra, organizations such as the American Welding Society (AWS) have developed welding codes that may be used to qualify new welders. These may be highly specialized and will depend on the type of work and the demands of a particular industry. Certifications tend to expire after a specific length of time. Accordingly, the welding station of the present application for patent may be used for new certification and recertification purposes throughout a welder's career.

Welding certification may include different types of welding, such as shielded metal arc (STICK) welding, inert gas metal arc (MIG) welding, flux cored arc welding, gas tungsten arc (TIG) welding. Other methodologies include resistance welding, brazing, soldering, plasma welding, laser welding, stud welding, and submerged arc welding. In addition, each of the above techniques may require certification on various orientations of the workpiece coupon, as well as different heights from overhead to waste level to floor level.

By way of example, in plate welding, certifications are coded according to the orientation of the plate, the direction of the weld on a given orientation, and the type of weld joint used. Table 1 provides a summary of the plate welding code.

TABLE 1
Plate Welding Codes

| Code | Interpretation | Weld Code | Interpretation |
|---|---|---|---|
| 1 | Plate in flat position. | F | Fillet weld joint. |
| 2 | Plate in horizontal position. | G | Groove weld joint |
| | Weld horizontal. | | |
| 3 | Plate in vertical position. | | |
| | Weld vertical. | | |
| 4 | Plate in overhead position. | | |

Thus, for example, a 2F qualification refers to a horizontal weld using a fillet joint while a 4G qualification refers to an overhead weld done using a groove joint.

As a further example, pipe welding is also frequently required. Certifications are coded according to the orientation of the pipe, whether the pipe is rotated or clamped, the type of weld joint used and whether the weld is restricted. Restricted welds occur when the welder must find unusual stances and body positions, when the welding field is obscured or blocked with other pipes, a ceiling or walls, and/or restrictive rings that would block access to the weld joint, and objects that block visual access, requiring the use of a mirror, camera or other device to provide a view of the weld.

As an example, a 1F qualification would require welding proficiency on a pipe that is horizontal and allows the pipe to rotate or roll, using a fillet weld joint, while a 6GR qualification would require proficiency welding a pipe in a 45° orientation, using a groove weld, under restrictive conditions.

TABLE 2
Pipe Welding Codes

| Code | Interpretation | Weld Code | Interpretation |
|---|---|---|---|
| 1 | Pipe horizontal, allowed to | F | Fillet weld joint. |
| | roll or rotate. | | |
| 2 | Pipe in fixed vertical position. | G | Groove weld joint |
| 5 | Pipe in fixed horizontal position. | | |
| 6 | Pipe in 45° fixed position. | | |
| R | Weld field restricted | | |

Weld field restrictions may be introduced that require the welder to find unusual stances and body positions, or contend with other pipes, a ceiling or walls, and/or restrictive rings that would block access to the weld joint, and objects that block visual access, requiring the use of a mirror, camera or other device to provide a view of the weld. Such restrictions may be clamped into place, anchored on the welding station or other nearby structure. It is particularly convenient for the restriction to be anchored on the Welding station so that the entire assembly can be moved without disturbing the restricted configuration. Obstructions or barriers may be, without limitation, pipes and arrays of pipes, plates or other planer materials, brackets and other mounting hardware, wire cables having a variety of coatings and encasements, gauges, valves, flanges and other pressure fittings, electrical conduits, and the like.

Although the present invention has been shown and described with reference to particular examples, various changes and modifications which are obvious to persons skilled in the art to which the invention pertains are deemed to lie within the spirit, scope and contemplation of the subject matter set forth in the appended claims.

What is claimed is:

1. A welding station for holding a workpiece, comprising:
a. a base;
b. a purge gas manifold, operatively connected to the welding station, or incorporated into the base, to act as a conduit for an unreactive purge gas;
c. a rotatable chuck stage for holding the workpiece, comprising a purge gas outlet, and having a first axis of rotation that allows the workpiece to swing into place at a desired angle, and a first detent to lock the motion of the rotatable stage once the desired angle in the first axis of rotation is attained.

2. The welding station of claim 1, further comprising a tack station for temporarily welding two or more workpiece components.

3. The welding station of claim 1, wherein the first detent is a slotted detent, a friction locked detent, a ball detent, or a ratcheted detent.

4. The welding station of claim 1, wherein the first detent is configured so that rotation may be locked at an angle of about 0°, about 30°, about 45°, about 60°, or about 90°.

5. The welding station of claim 4, wherein the first detent is a slotted detent.

6. The welding station of claim 1, wherein the chuck stage is configured to hold a cylindrically-shaped object or a flat plate.

7. The welding station of claim 1, wherein the rotatable chuck stage has a second axis of rotation, approximately normal to the chuck stage, that allows rotation about a workpiece axis, when in use.

8. The welding station of claim 1, further comprising a second detent to lock the rotational motion of the rotatable chuck stage once the desired angle in the second axis of rotation is attained.

9. The welding station of claim 8 wherein the second detent is a slotted detent, a friction locked detent, a ball detent, or a ratcheted detent.

10. The welding station of claim 8 wherein the chuck stage is configured to hold a cylindrically-shaped object or a flat plate.

11. The welding station of claim 1, further comprising a buffing station.

12. The welding station of claim 1, further comprising a cleaning station

13. The welding station of claim 1, further comprising a cutting station.

14. The welding station of claim 1, further comprising a shut-off valve in the purge gas manifold.

15. The welding station of claim 1, further comprising a torch cable holder for holding the torch cable conveniently.

16. The welding station of claim 1, further comprising a purge valve, for purging air from the gas manifold.

17. The welding station of claim 1, further comprising a restriction that blocks the welder's access to the weld.
